(19) United States
(12) Patent Application Publication
(10) Pub. No.: US 2011/0207037 A1
(43) Pub. Date: Aug. 25, 2011

(54) METHOD FOR FORMING FULL COLOR IMAGE AND FULL COLOR IMAGE FORMING APPARATUS

(75) Inventors: Hiroyuki YASUKAWA, Tokyo (JP); Hajime TADOKORO, Kanagawa (JP); Kaori SOEDA, Tokyo (JP); Hidemasa SAWADA, Tokyo (JP); Miyuki MURAKAMI, Kanagawa (JP); Yohei OHNO, Tokyo (JP)

(73) Assignee: KONICA MINOLTA BUSINESS TECHNOLOGIES, INC., Tokyo (JP)

(21) Appl. No.: 13/024,809

(22) Filed: Feb. 10, 2011

(30) Foreign Application Priority Data
Feb. 23, 2010 (JP) 2010-037055

(51) Int. Cl. G03G 13/01; G03G 15/01

(52) U.S. Cl. 430/42.1; 399/223

(57) ABSTRACT

Disclosed is a manufacturing method for forming a full color image and an apparatus for forming a full color image exhibiting excellent color chroma for a secondary color and extension of a color reproduction area in a range of red to orange color. A method for forming a full color image using at least six colors of an electrostatic image developing toner each comprising a resin and a colorant, wherein six colors of an electrostatic image developing toner are a yellow toner, a magenta toner, a cyan toner, an orange toner, a green toner and a black toner, and the colorant containing in the orange toner is a pyrazolone pigment.

This application is based on Japanese Patent Application No. 2010-037055 filed on Feb. 23, 2010, in Japanese Patent Office, the entire content of which is hereby incorporated by reference.

### TECHNICAL HELD

The present invention relates to a method for forming a full color image and a full color image forming apparatus.

### BACKGROUND

Recently, a full color image can be formed by an electrophotographic process image forming method employing a toner for developing an electrostatic image (referred also as “a tone” shortly hereafter) in addition to a monochrome image conventionally. Such a full color image forming method using a toner has been utilized in light printing field in which small amount of prints are mainly produced because it does not require printing plates and required amounts are prepared on demand.

The toner is required to have high color reproduction property to form an image reproducing color with high fidelity to the original in case that the full color printed matter such as catalogues or advertising material in particular. In case of including a person in the full color image, a reproduction of a skin color greatly influences an impression of the whole image.

Generally in a method for forming a full color image formed by an electrophotographic process, a target color is reproduced by combination of three color toners such as a yellow toner, a magenta toner and a cyan toner in principle. However, for example in case of reproducing a skin color, it is difficult to reproduce an image with target skin color sufficiently because chroma and luminance becomes lower due to superimposing toner images of a yellow toner and a magenta toner.

Over recent years, case increases in which an image is formed on display by using computer graphics and printed. However, color reproduction area of a full color image which can be formed by an electrophotographic process image forming method is too narrower than that which can be displayed on a display. Therefore, it is difficult to reproduce the full color image on a transfer body such as paper as its original hue of a display.

As one of a technology which extends a color reproduction area, known is a method for forming a full color image, for example, employing six-color or more toners by adding an orange toner and a green toner to four-color toners such as a yellow toner, a magenta toner, a cyan toner and a black toner. Herein, color hue represented by 360° in Munsell hue circle is not reproduced by using three-color toners constituted by a yellow toner, a magenta toner and cyan toner, but using five-color toners by adding an orange toner and a green toner thereto and thereby the color reproduction area can be extended.

However, by these methods for forming a full color image, for example, a color reproduction in a range of red to orange color such as skin color is not sufficient yet. In order to solve these problems, disclosed is a method for extending a color reproduction area in a range of red to orange color by using a magenta colorant and an orange colorant in combination (for example, see Patent Document 1). Further, disclosed is a method for extending a color reproduction area in a range of red to orange color by an orange toner using an orange colorant such as C.I. Pigment Orange 11 (for example, see Patent Documents 2 and 3).

However, a color reproduction in a range of red to orange color is still not sufficient, because most of orange colorants in these orange toners are inferior in a color chroma and a secondary color reproduced by superimposing toner images of the orange toner and the magenta toner exhibits low luminance and results in a color cross-over.

### PRIOR ART

### Patent Documents

Patent Document 1: Unexamined Japanese Patent Application (hereinafter, refers to as JP-A) No. 2008-3274
Patent Document 2: JP-A No. 2007-304401
Patent Document 3: JP-A No. 2002-156776

### SUMMARY

In view of the foregoing, the present invention was achieved. One of the objects of the present invention is to provide a method for forming a full color image and a full color image forming apparatus which exhibits excellent color chroma for a secondary color and extension of a color reproduction area in a range of red to orange color.

The method for forming a full color image of the present invention is characterized by using at least six colors of an electrostatic image developing toner each comprising a binder resin and a colorant, wherein six colors of an electrostatic image developing toner are a yellow toner, a magenta toner, a cyan toner, an orange toner, a green toner and a black toner; and the colorant contained in the orange toner is a pyrazolone pigment.

According to the present invention, in the method for forming the full color image, a content of the colorant contained in the orange toner is preferably 1 to 6 parts by mass based on the binder resin of 100 parts by mass.

According to the present invention, in the method for forming a full color image, the colorant contained in the orange toner is preferably one or more pigments selected from C.I. pigment orange 13 and C.I. pigment orange 34.

According to the present invention, in the method for forming a full color image, the orange toner is preferably prepared by step of coagulating and fusing fine particles of the colorant and fine particles of the binder resin by mixing a dispersion in which fine particles of the colorant is dispersed in an aqueous medium and a dispersion in which fine particles of the binder resin are dispersed in an aqueous medium.

The apparatus for forming a full color image of the present invention is characterized by the full color image being formed by above method.

According to the method for forming the full color image of the present invention, excellent color chroma for a secondary color and extension of a color reproduction area in a range of red to orange color can be achieved by using colorant contained in the orange toner comprising a pyrazolone pigment.

As for reasons for obtaining these effects, it is presumed that a pyrazolone pigment which constitutes a colorant contained in an orange toner has high tinting strength and can be highly dispersed in a binder resin which constitutes the orange toner due to using less content of the pyrazolone pigment than conventional colorant. Further, because the pyrazolone pigment has high tinting strength, a printing amount of the orange toner can be reduced and results in forming a color image exhibiting an excellent color chroma of a secondary color reproduced by superimposing other toner image.

According to the full color image forming apparatus of the present invention, the method for forming the full color image of the present invention can form an image which exhibits excellent color chroma for a secondary color and extension of a color reproduction area in a range of red to orange color.

### BRIEF DESCRIPTION OF DRAWING

FIG. 1 is a schematic cross-sectional view of an example of an image forming apparatus for operating the method for forming a full color image used in the present invention.

### DESCRIPTION OF THE PREFERRED EMBODIMENT

The present invention will now be detailed.

### <Method for Forming Full Color Image>

The method for forming a full color image of the present invention can be carried out by installing at least six colors of toners comprising yellow toner, magenta toner, cyan toner, green toner, black toner and orange toner containing the colorant of pyrazolone pigment onto the well-known full color image forming apparatus.

Toner having the other color than above six colors can be applicable to the method for forming the full color image of the present invention, for example, blue toner or gray toner.

The full color system image forming apparatus, which is carried out employing the full color system image forming method according to the present invention, includes at least the following processes: namely

(a) an electrostatic latent image forming process which forms electrostatic latent images on an electrostatic latent image carrier,
(b) a development process which forms toner images by developing electrostatic latent images formed on the electrostatic latent image carrier by employing a developer which is prepared by incorporating the toner according to the present invention,
(c) a transfer process which transfers toner images formed on the electrostatic latent image carrier onto a transfer body such as a sheet, and
(d) a fixing process which fixes the toner images transferred onto the transfer body.

Specific example of the method for forming a full color image according to the present invention includes method (1) or (2) described as follows:

(1) So-called a direct transfer method for forming a full color image may be possible to use an image forming method. The formation of an image is carried out as follows: to form an electrostatic latent image of an electrostatic latent image carrier; to form a toner image by developing the electrostatic latent image with a toner of at least six colors comprising yellow toner, orange toner, green toner, cyan toner, magenta toner and black toner; to transfer the formed toner image directly from the electrostatic latent image carrier to a transfer body; resulting in the transfer body carrying a plurality of toner images having different colors, then to fix the toner image on the transfer body to obtain a final fixed toner image.

(2) So-called an intermediate transfer method for forming a full color image may be possible to use an image forming method. The formation of an image is carried out as follows: to form an electrostatic latent image of an electrostatic latent image carrier, to form a toner image by developing the electrostatic latent image with a toner of at least six colors comprising yellow toner, orange toner, green toner, cyan toner, magenta toner and black toner; to transfer the formed toner image from the electrostatic latent image carrier to an intermediate transfer body, to transfer the formed toner image from the intermediate transfer body to a transfer body; then to fix the toner image on the transfer body to obtain a final fixed toner image.

A method for forming a full color image by the intermediate transfer system will now be detailed.

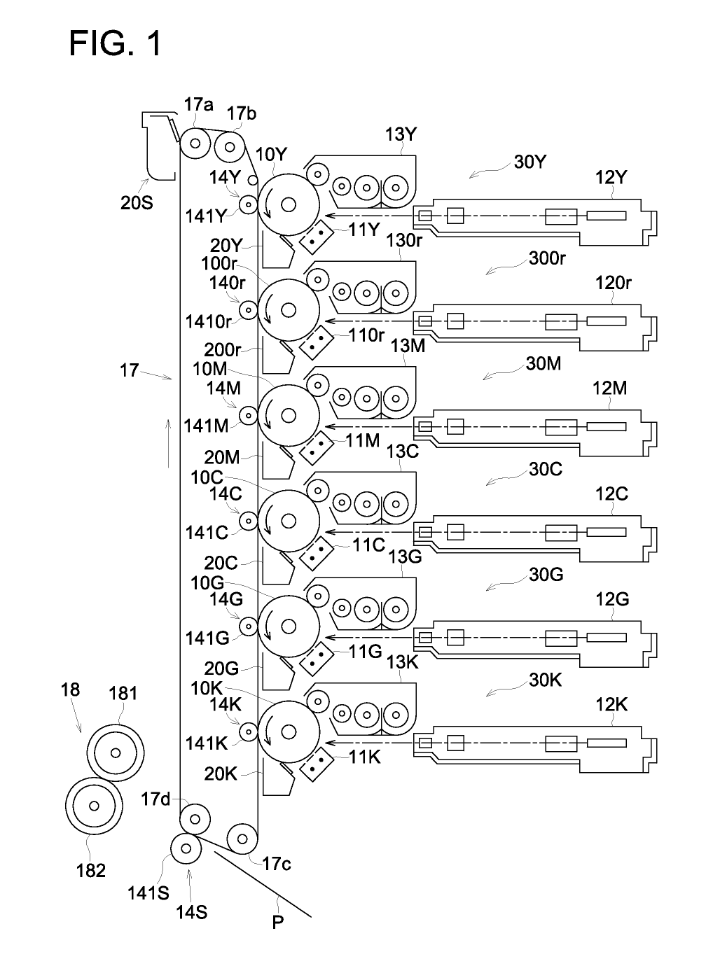

FIG. 1 is a schematic cross-sectional view of an example of an image forming apparatus for operating the method for forming the full color image used in the present invention.

This full color image forming apparatus is equipped with an intermediate transfer object 17 in a shape of an endless belt (hereinafter referred to as “intermediate transfer belt”) that is trained about a group of plural supporting rollers 17a-17d, and along the outer circumferential surface of the intermediate transfer object 17, there are provided six toner image forming units 30Y, 30Or, 30M, 30C, 30G, and 30K each forming a toner image with yellow, orange, magenta, cyan, green and black color to be away from each other so that the intermediate transfer object 17 may be moved circularly while touching each photoreceptor drum 10Y, 10Or, 10M, 10C, 10G, and 10K as a latent image carrier of the toner image forming unit relating to each color toner image.

Toner image forming unit 30Y relating to a yellow toner image is composed of rotating drum-shaped photoreceptor 10Y and charging means 11Y, exposure means 12Y, developing means 13Y, primary transfer mechanism 14Y and photoreceptor cleaning means 20Y, each are arranged along the outer circumferential surface of the photoreceptor 10Y to be in the order of operations in the direction of rotation of the photoreceptor 10Y.

Primary transfer mechanism 14Y is composed of primary transfer roller 141Y that is arranged to form primary transfer area (primary transfer nip) by pressing to photoreceptor drum 10Y through intermediate transfer belt 17 and transfer current supply mean (not illustrated) connected to primary transfer roller 141Y. Transfer electric field is formed by applying predetermined current to primary transfer roller 141Y via transfer current supply mean, whereby yellow toner image which is formed on photoreceptor drum 10Y is primary transferred onto intermediate transfer belt 17.

Further, each of other toner image forming units 30Or, 30M, 30C, 30G and 30K are also made to have the same structure as that of the toner image forming unit 30Y relating to the yellow toner, except for including developer for respectively orange toner, magenta toner, cyan toner, green toner and a black toner in place of yellow toner. In FIG. 1, as a matter of convenience, the same constituting members as toner image forming unit 30Y relating to a yellow toner image are shown by using same alphanumeric designations “Y”, and for each unit for other color by “Or”, “M”, “C”, “G” and “K”.

Secondary transfer mechanism 14S is provided at the position that is in a downstream side of the area of arrangement for the toner image forming units in the direction of movement of the intermediate transfer object 17.

Secondary transfer mechanism 14S is composed of secondary transfer roller 141S that is arranged to form secondary transfer area (secondary transfer nip) by pressing to back-up roller 17d which is one of supporting roller to intermediate transfer belt 17 through intermediate transfer belt 17 and transfer current supply mean (not illustrated) connected to secondary transfer roller 141S. Secondary transfer bias voltage having the polarity reverse to that of primary toner image is applied to the secondary transfer roller 141S, and a transfer field is formed in the transfer area, whereby the primary transferred toner image carried on the intermediate transfer member 17 is secondarily transferred onto the surface of the transfer body P.

In FIG. 1, 18 is a fixing member in which toner image on the transfer body conveyed from secondary transfer area is fixed and, for example, is composed of heat roller 181 having heat source inside and pressure roller 182 provided to form fix nip area with the heat roller 181.

Further, an intermediate transfer member cleaning unit 20S for removing the toner remaining on the intermediate transfer belt 17 is provided on the downstream side of the secondary transfer position, as viewed from the rotating direction of the intermediate transfer belt 17.

As specific example of fixation condition by fixing member shown in FIG. 1, a fixing temperature (surface temperature of heat roller 181) is preferable 70-160° C. and a nip width of a fixing nip portion provided with heat miler 181 and pressure roller 182 is preferable 5-40 mm. Herein, a fixing nip portion is defined as a width of contact between toner image formed on the transfer body P and a surface of the heat roller 181. Contact load between heat roller 181 and pressure roller 182 is preferably 40-350 N.

Thus, toner images are formed on the photoreceptors 10Y, 10Or, 10M, 10C, 10G and 10K in each toner image forming unit 30Y, 30Or, 30M, 30C, 30G and 30K, and are superimposed on the intermediate transfer belt 17 by transferred sequentially. Then, toner image primary transferred onto the intermediate transfer belt 17 is secondary transferred together to the transfer member P by secondary transfer mechanism 14S and fixed by applying pressure with heating in the fixing device 18, resulting in toner images are formed on the transfer member P.

### [Toner]

At least six colors of toner used in the method of the present invention for forming the full color image each comprise a binder resin and a colorant.

Further, each color toner used in the method of the present invention for forming a full color image each can comprise internal additives such as a magnetic powder, a charge control agent and a releasing agent.

### (Colorant)

The colorant composing the orange toner used in the method of the present invention for forming a full color image contains pyrazolone pigment such as C.I. Pigment Orange 13 and C.I. Pigment Red 34. These may be employed individually or in combinations of at least two types. Among these, C.I. Pigment Red 13 is preferably used due to having high color chroma and C.I. Pigment Red 34 is preferably used due to having high light fastness.

Content of colorant in an orange toner is preferably 1 to 6 parts by mass based on 100 parts of a binder resin, more preferably 1 to 4 parts by mass. A brilliant color reproduction without color cross-over in a range of red to orange color can be realized in case that a content of colorant in an orange toner is within above range.

It is preferable that the colorant in an orange toner is dispersed with a number average primary particle diameter of about 50 to 500 nm in each toner particles.

Cross section of an orange toner is at a magnification of 50,000 times by a transmission electron microscope. Then, a number average primary particle diameter can be evaluated by measuring Feret's diameters of colorant fine particles in ten orange toner particles by using photography of toners and calculates its arithmetic mean value.

Colorant contained in orange toner may include a conventional orange colorant other than pyrazolone pigment. In this case, content of the orange colorant is preferably less than 40 parts by mass based on 100 parts of the pyrazolone pigment.

Further, as a toner other than orange toner used in the method of the present invention for forming the full color image, conventional toners can be applicable.

The colorant for a yellow toner includes, for example, C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, and C.I. Solvent Yellow 162, C.I Pigment Yellow 14, C.I Pigment Yellow 17, C.I Pigment Yellow 74, C.I Pigment Yellow 93, C.I Pigment Yellow 94, C.I Pigment Yellow 138, C.I Pigment Yellow 155, C.I Pigment Yellow 180, and C.I Pigment Yellow 185, as well as mixture thereof. Among those, C.I Pigment Yellow 74 is preferably used.

Content of colorant in a yellow toner is preferably 1 to 10 parts by mass based on 100 parts of a binder resin, more preferably 2 to 8 parts by mass.

The colorant for a magenta toner includes, for example, C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I Pigment Red 5, C.I Pigment Red 48:1, C.I Pigment Red 53:1, C.I Pigment Red 57:1, C.I Pigment Red 122, C.I Pigment Red 139, C.I Pigment Red 144, C.I Pigment Red 149, C.I Pigment Red 166, C.I Pigment Red 177, C.I Pigment Red 178 and C.I Pigment Red 222, as well as mixture thereof. Among those, C.I Pigment Red 122 is preferably used.

Content of colorant in a magenta toner is preferably 1 to 10 parts by mass based on 100 parts of a binder resin, more preferably 2 to 8 parts by mass.

The colorant for a cyan toner includes, for example, C.I. pigment blue 15:3.

Content of colorant in a cyan toner is preferably 1 to 10 parts by mass based on 100 parts of a binder resin, more preferably 2 to 8 parts by mass.

The colorant for a green toner includes, for example, C.I. Pigment green 7.

Content of colorant in a green toner is preferably 1 to 10 parts by mass based on 100 parts of a binder resin, more preferably 2 to 8 parts by mass.

The colorant to be used in the black toner includes, for example, carbon black and magnetic substances and titan black. As the carbon black, for example, channel black, furnace black, acetylene black, thermal black and lamp black are usable. The magnetic substance include a ferromagnetic metal such as iron, nickel and cobalt, alloys containing such the metal, compounds of ferromagnetic metal such as ferrite and magnetite, alloys which displays ferromagnetism by heating treatment though contains no ferromagnetic metal such as alloys of manganese-copper-aluminum and manganese-copper-tin so called as Heusler's alloy, and chromium dioxide.

Content of colorant in a black toner is preferably 1 to 10 parts by mass based on 100 parts of a binder resin, more preferably 2 to 8 parts by mass.

It is preferable that the colorant in yellow toner, magenta toner, cyan toner, green toner and black toner are preferably dispersed with a number average primary particle diameter of about 50 to 500 nm in each toner particles.

### (Binder Resin)

As a binder resin used in the method for forming the full color image of the present invention, the publicly known resins can be used without particular limitation.

When the toner particles are prepared with a toner pulverization method, examples of a binder resin include: a vinyl resin such as a styrene resin, a (meth)acrylic resin, a styrene-(meth)acrylic copolymer resin and an olefin resin; and further, a polyester resin, a polyamide resin, a polycarbonate resin, a polyether resin, a vinyl acetate resin, a polysulfone resin, an epoxy resin, a polyurethane resin and a urea resin. These can be used individually or in combinations of at least 2 types.

When the toner particles are prepared with a suspension polymerization method, or an emulsion polymerization aggregation method, a various known polymerizable monomer such as a vinyl monomer can be used for preparing a various kinds of resins which constitute the toner particles. It is preferable that a polymerizable monomer containing an ionic-dissociative group in the molecule is used in combination with the aforesaid monomer. Further, a multifunctional vinyl monomer can be used as a polymerizable monomer to obtain a cross-linkable binder resin.

### [Charge Control Agent]

A charge control agent can be employable without particular limitation while it is a material which can provides positive or negative charge by triboelectric charging. Well-known positive and negative charge control agents can be used.

Specific example of the positive charge control agent include: dye of nigrosine series such as “Nigrosine base EX” (manufactured by Orient Chemical Industry Co., Ltd); quaternary ammonium salt such as “quaternary ammonium salt P-51” (manufactured by Orient Chemical Industry Co., Ltd) and “Copy charge PX VP435” (manufactured by Hoechst Japan); alkoxylated amine, alkylamide, molybdate chelate pigment, and imidazole compound such as “PLZ1001” (manufactured by Shikoku Chemicals Corporation).

Specific example of the negative charge control agent include: metal complex such as “BONTRON S-22”, “BONTRON S-34”, “BONTRON E-81”, “BONTRON E-84” (all manufactured by Orient Chemical Industry Co., Ltd), and “Spiron Black TRH” (manufactured by Hodogaya Chemical Co., Ltd); thioindigo pigment, quaternary ammonium salt such as “Copy charge NX VP434” (manufactured by Hoechst Japan); calixarene compound such as “BONTRON E-89” (manufactured by Orient Chemical Industry Co., Ltd), boron compound such as “LR147” (manufactured by Japan Carlit Co., Ltd), magnesium fluoride and carbon fluoride. Specific examples of metal complex as the negative charge control agent other than above include metal complex having various structure such as oxycarbonate metal complex, dicarbonate metal complex, amino acid metal complex, diketone metal complex, diamine metal complex, benzene containing azo group-benzene derivative skeleton metal complex.

Content of charge control agent is preferably 0.01 to 30 parts by mass based on 100 parts by mass of a binder resin, more preferably 0.1 to 10 parts by mass.

### (Releasing Agent)

A various conventional wax can be used as the releasing agent. Specific examples of a wax include: a polyolefin wax such as polyethylene wax and polypropylene wax; a branched chain hydrocarbon such as microcrystalline wax; a long chain hydrocarbon such as paraffin wax and sazole wax; a dialkylketone wax such as distearilketone; an ester wax such as carnauba wax, montan wax, behenic acid behanate, trimethylpropane tribehenate, pentaerythritol tetrabehenate, pentaerythritol diacetate dibehenate, glycerine tribehenate, 1,18-octadecanediol distearate, trimerit acid tristearyl, and distearyl maleate; and an amide wax such as ethylenedimine behenylamide and trimerit acid tristearylamide.

Content of releasing agent is preferably 0.1 to 30 parts by mass based on 100 parts by mass of a binder resin, more preferably 1 to 20 parts by mass.

### (Manufacturing Method of Toner)

Each toner used in the full color image forming method of the present invention can be manufactured by steps of providing toner particles by using a binder resin, a colorant and, as appropriate, an inner additive; and adding an external additive to the toner particles, as appropriate.

Manufacturing method of each toner include conventional methods such as a pulverizing method, a suspension polymerization method, as well as other methods. Of these, an emulsion polymerization aggregation method is preferably employed. By the emulsion polymerization aggregation method, small sized tone particles can be easily obtained from the viewpoints of a manufacturing cost and a manufacturing stability.

Herein, the emulsion polymerization aggregation method is a method for manufacturing toner particles comprising steps of mixing a dispersion of binder resin fine particles obtained by the emulsion polymerization method (hereinafter, refer to as “binder resin particles”) and a dispersion of colorant fine particles (hereinafter, refer to as “colorant particles”), coagulating to the predetermined toner particle size and further controlling a shape of particles by fusing binder resin particles.

Specific example of the emulsion polymerization aggregation method as manufacturing method of the toner includes process of:

(1) preparing a dispersion in which fine particles of the colorant is dispersed in an aqueous medium,
(2) preparing a dispersion in which fine particles of the binder resin which contains an internal additive as appropriate are dispersed in an aqueous medium,
(3) preparing toner particles by coagulating and fusing a fine particles of the colorant and fine particles of the resin by mixing the dispersion of the colorant fine particles and the dispersion of the binder resin particles,
(4) eliminating a surfactant from the toner particles by filtering the dispersion of the toner particles (in aqueous medium),
(5) drying the toner particles, and
(6) adding an external additive to the toner particles.

When toner is manufactured by the emulsion polymerization aggregation method, binder resin particles prepared by emulsion polymerization method may have multi-layered structure of two or more layers comprising binder resins having different composition. These binder resin particles, for example, having two-layer structure, can be provided by preparing a binder resin particle dispersion according to the conventional emulsion polymerization method (first stage polymerization) followed by adding a polymerization initiator and polymerizable monomer to the dispersion and polymerizing (second stage polymerization).

Toner having a core shell structure can be manufactured by the emulsion polymerization aggregation method. When the toner having a core shell structure is manufactured, core particles are manufactured by aggregation, association and fusion between resin particles for core particles and coloring agent particles. Then resin particles are added into the core particle dispersion to cause coagulation and fusion of these resin particles to the core particles surface, whereby the core particles surface is covered, and colored particles having a core shell structure are manufactured.

Orange toner used to the method for forming a full color image of the present invention is preferred to be prepared by step of coagulating and fusing a fine particles of the colorant and fine particles of the resin by mixing a dispersion in which fine particles of the colorant is dispersed in an aqueous medium and a dispersion in which fine particles of the resin are dispersed in an aqueous medium, namely by the emulsion polymerization aggregation method. The reason why this method is preferred is considered as bellows: as colorant contained in orange toner, a pyrazolone pigment which has high tinting strength is used, whereby a content of the colorant can be reduced, resulting in exhibiting excellent dispersion of colorant particles in colorant dispersion. Further, toner particles can be formed by keeping excellent dispersion of colorant particles even after step of coagulating and fusing a fine particles of the colorant and fine particles of the resin.

The volume based median diameter of orange colorant particles is preferably 100-300 nm in the step (1) above.

The volume-based median diameter was measured by using MICROTRAC UPA-150 (HONEYWELL) under measurement conditions below:

Diffractive index of sample: 1.59

Specific gravity of sample: 1.05 (conversion by spherical particle) Diffractive index of solvent; 1.33

Viscosity of solvent: 0.797 (30° C.), 1.002 (at 20° C.)

0 point adjustment: adjusting by ion-exchanged water in measurement cell.

Example of using a pulverizing method as a method for preparing toner is described below

(I) mixing step in which binder resin, colorant and inner additive as appropriate are mixed by mixer such as Henshel mixer,
(II) kneading step in which above obtained mixture is kneaded by extruder under heating,
(III) grinding step in which above kneaded material is coarsely grinded by Hammer mil followed by further grinding by Turbo mill,
(IV) step of forming toner in which above grinded material is classified by a flow classification apparatus such as applying the Coanda effect, and
(V) step of adding external additives to toner particles.

### (Particle Diameter of the Toner)

The particle diameter of a toner particle is specifically preferable a volume-based median diameter of 4-10 μm, more preferable 5-9 μm. The toner having such particle diameter can reproduce high quality image such as thin line and dot because of high quality reproduction of half tone due to high transfer efficiency.

The volume-based median diameter of toner particles can be measured and calculated by using Coulter Multisizer 3 (Beckman Coulter Co.), connected to a computer system (Beckman Coulter Co.).

Specifically, the measurement procedure is as follows: 0.02 g of toner particles are added to 20 ml of a surfactant solution (for example, a surfactant solution obtained by diluting a surfactant containing neutral detergent with pure water to a factor of 10) and dispersed in an ultrasonic homogenizer to prepare toner dispersion. Using a pipette, the toner dispersion is placed into a beaker containing ISOTON II (produced by Beckman Coulter Co.) within a sample stand, until reaching a measurement concentration of 5-10%. Measurement value with good reproduce ability can be obtained by controlling within this measurement concentration. The measurement particle count number was set to 25,000 to perform measurement. Then aperture diameter was 50 μm. The measurement range of 1 to 30 μm was divided into 256 portions to determine the frequency number. A particle size corresponding to 50% of the volume-integrated fraction from the larger particles was defined as a volume-based median diameter.

### (Softening Point Temperature of Toner)

It is preferable that the toner of the present invention has a softening point (Tsp) of not less than 70° C. and not more than 110° C., and more preferably not less than 70° C. and not more than 100° C. The colorant incorporated in the toner of this invention has a stable property in which does not change reflection spectrum does not change when it is subjected to heat, and the affect by heat applied to the toner as well as the colorant is reduced, and consequently it is expected that an image having stable color reproduction property widely can be formed when the Tsp satisfies the above mentioned temperature range

When the softening point toner (Tsp) satisfies the abovementioned temperature range, toner image can be fixed by lower temperature than conventional fixing temperature, and power for fixing can be reduced and therefore, environmental load is also reduced.

The softening point temperature of the toner (Tsp) can be controlled by, for example, the following method singly or in combination with two or more.

(1) Controlling species and content ratio of monomers for forming binder resin of the toner particles.
(2) Controlling molecular weight of the binder resin for forming the toner particles by adjusting species and amount of the chain transfer agent for forming the binder resin.
(3) Adjusting species and amount of wax and so on contained in the toner particles.

Specific example for adjusting a softening point temperature of the toner includes lowering molecular weight of the binder resin such as lowering the molecular weight of a binder corresponding to main peak in molecular weight distribution or narrowing the distribution. Further, a softening point temperature of the toner can be lowered by lowering a glass transition temperature Tg of a binder resin. In case of vinyl based resin, the glass transition temperature Tg of the binder resin can be lowered by using monomer having lower homopolymer Tg or by increasing a ratio of monomer having lower homopolymer Tg for binder resin composition.

The softening point of the toner is measured by the following method: The toner is formed into a cylinder shape having a height of 10 mm and set in a plunger of a measuring device, Flow Tester CFT-500 manufactured by Shimadzu Corp., and extruded through a nozzle having a diameter of 1 mm and a length of 1 mm while applying a load of 1.96×10⁶ Pa and heating at a temperature rising rate of 6° C./min. Then a plunger falling distance-temperature curve (softening flowing curve) is drawn and the softening point is determined by a temperature corresponding to a falling distance of 5 mm.

### (External Additive)

The colorant particles contained in the toner used in the image forming method of the present invention can constitute toner particles as they stand. However, it may be possible to add so called an external additive so as to improve properties such as fluidity, charging property and cleaning property to toner particles.

Specific example of the external additive include: inorganic oxide particles such as silica, alumina and titan oxide; inorganic stearate compound particles such as aluminum stearate and zinc stearate; and inorganic titanate compound particles such as strontium titanate and zinc titanate.

These inorganic particles are preferably subjected to a surface treatment with a slime coupling agent, a titanium coupling agent, a high fatty acid or a silicone oil.

A content of the external additive is from 0.05 to 5 parts by mass based on the toner particles of 100 parts by mass, and more preferably it is from 0.51 to 3 parts by mass. A plurality of different kinds of external additive may be jointly used.

### (Developer)

The toner according to the present invention can be used as a non-magnetic single component developer, or it can be used in a double component developer mixed with a carrier. With respect to black toner, it can be used in a magnetic single component developer. When the toner is used in a double component developer, magnetic particles made of the known materials can be used as a carrier. Examples of the known material include: a ferromagnetic metal such as iron; an alloy made of the ferromagnetic metals and other metal such as aluminum or lead; and a ferromagnetic compound such as ferrite and magnetite. In particular, ferrite particles are preferable. It can be used resin coated carriers which are coated with a coating material such as resin on the surface of the magnetic particles, or binder type carriers which are made by dispersing the magnetic particles in a binder resin. The coating resins which constitute the resin coated carrier are not specifically limited. Examples of the coating resins include: a polyolefin resin, a polystyrene resin, a styrene-acrylic copolymer resin, a silicone resin, a polyester resin and a fluorinated resin. The binder resins which constitute the binder type carrier are also not specifically limited. Examples of the binder resins include: a styrene-acrylic copolymer resin, a polyester resin, a fluorinated resin and a phenol resin.

The volume based median diameter of the carriers is preferably 20-100 μm, and more preferably it is 20-60 μm. The volume based median diameter of the carriers can be measured with, for example, “HELOS” (made by SYMPATEC Co. Ltd.), a particle size distribution measuring apparatus using a laser diffraction provided with a wet type dispersing device.

### (Transfer Body)

A transfer body usable in the full color image forming method of the present invention include: a plain paper such as a thin paper to a thick paper, a wood-free paper, an art paper, a printing paper of a coated paper, a commercial Japanese paper and a postcard printing paper, a plastic film for overhead projector, and cloth but is not limited to them.

Embodiments of the method for forming a full color image of the present invention described above is not limited thereto, and various modifications can be employable.

According to the present invention, pyrazolone pigment as the colorant contained in the orange toner of the method for forming the full color image can result in exhibiting excellent color chroma for a secondary color and extension of a color reproduction area in a range of red to orange color.

### EXAMPLES

Embodiments of the present invention will now be specifically described with the reference to examples, however the present invention is not limited thereto.

### Orange Toner Preparation Example 1

### Toner Preparation by Pulverizing Method

### (1) Mixing Step

Mixture was obtained by mixing materials below by Henshel mixer (manufactured by Mitsui Mining Co., Ltd) for 5 minutes under agitation blade circumferential velocity of 25 m/seconds.

| | |
|---|---|
| Polyester resin (condensate of bisphenol A-ethylene | 100 parts by mass |
| oxide adduct, terephthalic acid and trimellitic | |
| acid: weight average molecular weight 20,000) | |
| Colorant (C.I. Pigment Orange 13) | 4 parts by mass |
| Releasing agent (pentaerythritol tetrastearate) | 6 parts by mass |
| Charge control agent (boron dibenzilic acid) | 1 parts by mass |

### (2) Kneading Step

Obtained mixture was kneaded by twin screw extruder under heating at 110° C. to obtain kneaded material, followed by cooling the kneaded material.

### (3) Grinding Step

Obtained kneaded material was coarse grinded by Hammer mil (manufactured by Hosokawa Micron Corporation), followed by further grinding by “Turbo mill type T-400” (manufactured by Turbo Kogyo Co., Ltd).

### (4) Classifying Step

Orange toner particles [1] having volume based median diameter of the 5.5 μm were obtained by classifying obtained fine particles by a flow classification apparatus.

### (5) Adding Step of External Additives

Orange toner [1] was prepared by adding external additives below to Orange toner particles [1] followed by external additive treatment conducted by employing Henschel Mixer (Mitsui Miike Machinery Co., Ltd). The number average primary particle diameter of the dispersed colorant in Orange Toner [1] was 230 nm. This number average primary particle diameter was measured by the method described above. The softening point temperature (Tsp) of Orange Toner [1] was 110° C.

| | |
|---|---|
| Silica treated by hexamethyl silazane | 0.6 parts by mass |
| Titanium dioxide treated by n-octyl silane | 0.8 parts by mass |

The external additive treatment employing Henschel Mixer was conducted in a condition of circumferential speed of the agitation blade at 35 msec, processing temperature at 35° C., processing time for 15 minutes.

### Orange Toner Preparation Example 2

### Toner Preparation by Emulsion Polymerization Aggregation Method

### (1) Preparation of Dispersion Liquid of Colorant Particles [1]

Surfactant aqueous solution was prepared by adding and mixing to dissolve 11.5 parts by mass of sodium n-dodecylsuofate in 160 parts by mass of ion-exchanged water. Into the surfactant aqueous solution, 15 parts by mass of colorant (C.I. Pigment Orange 13) was gradually added, and dispersed via Cleannix W motion CLM-0.8 (Emtechnic) to prepare dispersion liquid of colorant particles [1]. The volume-based median diameter of colorant particles in the dispersion liquid of colorant particles [1] was 220 nm.

### (2) Preparation of Resin Particles for Core Part [1]

Resin Particles for Core Part [1] having multiple layer structure was prepared by the first, second and third stage polymerization described below.

### (a) First Stage Polymerization

Placed in a vessel fitted with a stirrer, a temperature sensor, a cooling pipe, and a nitrogen introducing device was a surface active agent solution prepared by dissolving 4 parts by mass of poly(oxyethylene)-2-dodecyl ether sodium sulfonate in 3,040 parts by mass of ion-exchanged water, and inside temperature was increased to 80° C. while stirring at a stirring speed of 230 rpm under nitrogen stream.

Into the surfactant aqueous solution above, polymerization initiator solution prepared by dissolving 10 parts by mass of potassium persulfate in 400 parts by mass of ion-exchanged water was added. After temperature was increased to 75° C., a monomer mixture liquid composed of the following compounds was dropped into vessel in one hour.

| | |
|---|---|
| Styrene | 532 parts by mass |
| n-Butyl acrylate | 200 parts by mass |
| Methacrylic acid | 68 parts by mass |
| n-Octyl mercaptan | 16.4 parts by mass |

After dropping above monomer mixture liquid, polymerization (the first stage polymerization) was conducted by heating and agitating at 75° C. for 2 hours, and Resin Particles [A1] was prepared. The Resin Particles [A1] had weight average molecular weight of 16,500.

### (b) Second Stage Polymerization

Monomer mixture liquid composed of the following compounds was placed into a flask equipped with an agitation device, then, 93.8 parts by mass of paraffin wax “HNP-57” (product by Nippon Seiro Co., Ltd.) was added as a releasing agent, and was dissolved by increasing the temperature up to 90° C. Thus monomer solution was prepared.

| | |
|---|---|
| Styrene | 101.1 parts by mass |
| n-Butyl acrylate | 62.2 parts by mass |
| Methacrylic acid | 12.3 parts by mass |
| n-Octylmercaptan | 1.75 parts by mass |

Surfactant aqueous solution was prepared by dissolving 3 parts by mass of poly(oxyethylene)-2-dodecyl ether sodium sulfonate in ion-exchanged water of 1,560 parts by mass, temperature was raised to 98° C. Into the surfactant aqueous solution, 32.8 parts by mass (converted into solid substance) of Resin Particles [A1] was added, and, monomer solution containing above described paraffin wax was added. The resulting material was dispersed by employing mechanical homogenizer “CLEARMIX” (produced by M Technique Co.) having a circulation channel for 8 hours. Emulsion particles dispersion liquid containing emulsion particles having dispersion particle diameter of 340 nm was prepared.

Then, polymerization initiator solution prepared by dissolving 6 parts by mass of potassium persulfate in 200 parts by mass of ion-exchanged water was added to above described emulsion particles dispersion liquid, Resin Particles [A2] was prepared by conducting polymerization (the second stage polymerization) in which the resulting material was subjected to agitation with heating at 98° C. for 12 hours. Weight average molecular weight of Resin Particles [A2] prepared by the second stage polymerization was 23,000.

### (c) Third Stage Polymerization

Polymerization initiator solution prepared by dissolving 5.45 parts by mass of potassium persulfate in 220 parts by mass of ion-exchanged water was added to Resin Particles [A2], and monomer mixture liquid composed of the following composition was dropped for 1 hour at 80° C. to it.

| | |
|---|---|
| Styrene | 293.8 parts by mass |
| n-Butyl acrylate | 154.1 parts by mass |
| n-octylmercaptan | 7.08 parts by mass |

After completion of addition, polymerization (the third stage polymerization) was conducted by agitation with heating for 2 hours. Resin Particles for Core Part [1] was prepared by cooling down to 28° C. after polymerization reaction. Resin Particles for Core Part [1] had weight average molecular weight of 26,800.

### (3) Preparation of Resin Particles for Shell [1]

Resin Particles for Shell [1] was prepared in the same manner as Resin Particles for Core Part [1] except that the monomer mixture liquid used in the preparation of first stage polymerization was replaced by the following compounds, and polymerization reaction and treatment after reaction were conducted

| | |
|---|---|
| Styrene | 624 parts by mass |
| 2-Ethylhexyl acrylate | 120 parts by mass |
| Methacrylic acid | 56 parts by mass |
| n-Octylmercaptan | 16.4 parts by mass |

### (4) Preparation of Orange Toner [2]

### (a) Preparation of Core Part

Into a reaction vessel equipped with agitation device, temperature sensor, a condenser tube, a nitrogen introducing device,

| | |
|---|---|
| Resin Particles for Core Part (1) | 420.7 parts by mass of |
| | (converted to solid substance) |
| Ion-exchanged water | 900 parts by mass |
| Dispersion liquid of colorant particles [1] | 200 parts by mass |

were introduced and were agitated. Temperature inside of the reaction vessel was adjusted at 30° C., and pH was controlled between 8 and 11 by adding 5 mol/L of aqueous solution of sodium hydroxide.

Then, aqueous solution prepared by dissolving 2 parts by mass of magnesium chloride hexa hydrate in 1,000 parts by mass of ion-exchanged water was added thereto at 30° C. with agitation taking 10 minutes. Heating-up was started after 3 minutes standing, the temperature was raised up to 65° C. taking 60 minutes, whereby association of the particles was conducted. In this state, particle diameter of the association particles was measured by employing “MULTISIZER 3” (product by Coulter Inc.), when the volume based median diameter of the association particles reaches 5.5 μm, aqueous solution prepared by dissolving 40.2 parts by mass of sodium chloride in ion-exchanged water 1000 parts by mass was added to terminate the association.

After termination of association fusion was continued by ripening treatment wherein agitation with heating was conducted at liquid temperature of 70° C. for 1 hour, thus Core Part [1] was prepared.

Average circularity of the Core Part [1] measured by “FPIA2100” (product by Sysmex Corp.) was 0.912.

### (b) Forming Shell Layer

The above obtained liquid was adjusted at 65° C. and 50 parts by mass (converted into solid substance) of Resin Particles for Shell [1] was added thereto. Further, aqueous solution prepared by dissolving 2 parts by mass of magnesium chloride hexa hydrate in 1,000 parts by mass of ion-exchanged water was added taking 10 minutes, temperature was raised up to 70° C., and agitation was conducted for 1 hour. Thus, Resin Particles for Shell [1] was fused on the surface of the Core Part [1], shell was formed by conducting ripening treatment at 75° C. for 20 minutes.

Then, shell forming was terminated by adding aqueous solution prepared by dissolving 40.2 parts by mass of sodium chloride in 1,000 parts by mass of ion-exchanged water. It was cooled to 30° C. at a rate of 8° C./minute, produced colored particles were filtrated, rinsed with ion-exchanged water at 45° C. repeatedly, dried by warm air at 40° C. Thus Orange Toner Particles [2] having shell layer on the surface of the core part was prepared.

(c) External Additive Treatment

Orange Toner [2] composed of Orange Toner Particles [2] was prepared in which the following external additives was added to Orange Toner Particles [2] thus prepared, and external additive treatment was conducted by employing Henschel Mixer (Mitsui Miike Machinery Co., Ltd). The number average primary particle diameter of the dispersed colorant in Orange Toner [2] was 250 nm. This number average primary particle diameter was measured by the method described above. The softening point temperature (Tsp) of Orange Toner [2] was 107° C.

| | |
|---|---|
| Silica treated by hexamethyl silazane | 0.6 parts by mass |
| Titanium dioxide treated by n-octyl silane | 0.8 parts by mass |

The external additive treatment employing Henschel Mixer was conducted in a condition of circumferential speed of the agitation blade at 35 msec, processing temperature at 35° C., processing time for 15 minutes.

### Orange Toner Preparation Example 3

Orange Toner [3] was prepared by the same manner as in the preparation process of Orange Toner Preparation Example 1, except that “C.I. Pigment Orange 34” was used in place of “C.I. Pigment Orange 13”. The number average primary particle diameter of the dispersed colorant in Orange Toner [3] was 230 nm. The softening point temperature (Tsp) of Orange Toner [3] was 110° C.

### Orange Toner Preparation Example 4

Orange Toner [4] was prepared by the same manner as in the preparation process of Orange Toner Preparation Example 2, except that “C.I. Pigment Orange 34” was used in place of “C.I. Pigment Orange 13”. The number average primary particle diameter of the dispersed colorant in Orange Toner [4] was 250 nm. The softening point temperature (Tsp) of Orange Toner [4] was 107° C.

### Orange Toner Preparation Example 5

Orange Toner [5] was prepared by the same manner as in the preparation process of Orange Toner Preparation Example 1, except that “C.I. Pigment Orange 34” was used in place of “C.I. Pigment Orange 13” and the content of pigment was changed to 8 parts by mass. The number average primary particle diameter of the dispersed colorant in Orange Toner [5] was 580 nm. The softening point temperature (Tsp) of Orange Toner [5] was 110° C.

### Orange Toner Preparation Example 6

Orange Toner [6] was prepared by the same manner as in the preparation process of Orange Toner Preparation Example 2, except that “C.I. Pigment Orange 64” was used in place of “C.I. Pigment Orange 13” and the content of pigment was changed to 30 parts by mass. The number average primary particle diameter of the dispersed colorant in Orange Toner [6] was 610 nm. The softening point temperature (Tsp) of Orange Toner [6] was 107° C.

### Yellow Toner Preparation Example 1

Yellow toner [1] was prepared in the same manner as in the preparation process of Orange Toner Preparation Example 1, except that “C.I Pigment Yellow 74” was used in place of “C.I. Pigment Orange 13”. The softening point temperature (Tsp) of Yellow Toner [1] was 110° C.

### Yellow Toner Preparation Example 2

Yellow toner [2] was prepared in the same manner as in the preparation process of Orange Toner Preparation Example 2, except that “C.I Pigment Yellow 74” was used in place of “C.I. Pigment Orange 13”. The softening point temperature (Tsp) of Yellow Toner [2] was 107° C.

### Magenta Toner Preparation Example 1

Magenta toner [1] was prepared in the same manner as in the preparation process of Orange Toner Preparation Example 1, except that “C.I Pigment Red 122” was used in place of “C.I. Pigment Orange 13”. The softening point temperature (Tsp) of Magenta Toner [1] was 110° C.

### Magenta Toner Preparation Example 2

Magenta toner [2] was prepared in the same manner as in the preparation process of Orange Toner Preparation Example 2, except that “C.I Pigment Red 122” was used in place of “C.I. Pigment Orange 13”. The softening point temperature (Tsp) of Magenta Toner [2] was 107° C.

### Cyan Toner Preparation Example 1

Cyan toner [1] was prepared in the same manner as in the preparation process of Orange Toner Preparation Example 1, except that “C.I Pigment Blue 15:3” was used in place of “C.I. Pigment Orange 13”. The softening point temperature (Tsp) of Cyan Toner [1] was 110° C.

### Cyan Toner Preparation Example 2

Cyan toner [2] was prepared in the same manner as in the preparation process of Orange Toner Preparation Example 2, except that “C.I Pigment Blue 15:3” was used in place of “C.I. Pigment Orange 13”. The softening point temperature (Tsp) of Cyan Toner [2] was 107° C.

### Green Toner Preparation Example 1

Green toner [1] was prepared in the same manner as in the preparation process of Orange Toner Preparation Example 1, except that “C.I Pigment Green 7” was used in place of “C.I. Pigment Orange 13”. The softening point temperature (Tsp) of Green Toner [1] was 110° C.

### Green Toner Preparation Example 2

Green toner [2] was prepared in the same manner as in the preparation process of Orange Toner Preparation Example 2, except that “C.I Pigment Green 7” was used in place of “C.I. Pigment Orange 13”. The softening point temperature (Tsp) of Green Toner [2] was 107° C.

### Black Toner Preparation Example 1

Black toner [1] was prepared in the same manner as in the preparation process of Orange Toner Preparation Example 1, except that “Carbon Black Mogul L” was used in place of “C.I. Pigment Orange 13”. The softening point temperature (Tsp) of Black Toner [1] was 110° C.

### Black Toner Preparation Example 2

Black toner [2] was prepared in the same manner as in the preparation process of Orange Toner Preparation Example 2, except that “Carbon Black Mogul L” was used in place of “C.I. Pigment Orange 13”. The softening point temperature (Tsp) of Black Toner [2] was 107° C.

### [Preparation of Developers]

Orange Developers [1]-[6], Yellow Developers [1] and [2], Magenta Developers [1] and [2], Cyan Developers [1] and [2], Green Developers [1] and [2], and Black Developers [1] and [2], having a toner content of 6% were prepared by adding a ferrite carrier covered with methylmethacrylate and cyclohexylmethacrylate resin having volume average particle diameter of 50 μm to each of Orange Toners [1]-[6], Yellow Toners [1] and [2], Magenta Toners [1] and [2], Cyan Toners [1] and [2], Green Toners [1] and [2], and Black Toners [1] and [2].

### Examples 1-4, and Comparative Examples 1 and 2

Developers in combination as shown in Table 1 were installed in the developing member of “bizhub Pro C500” (product by Konica Minolta Business Technologies, Inc.) corresponding to a full color image forming apparatus multi work color printer illustrated in FIG. 1 in a market. By setting a surface temperature of heat roll at 150° C. and a nip width of fixing nip portion at 10 mm, the following evaluation was conducted.

### [Evaluation Method]

### (1) Color Reproduction Area

Each of yellow monochrome (Y), magenta monochrome (M), cyan monochrome (C), red (R), blue (B) and green (G) solid image in an area of 2 cm×2 cm was formed in a circumstance at a temperature of 20° C., and humidity of 50% RH, exhibit color gamut in a*-b* coordinate in L*a*b* color system, and the color reproduction area was measured. Color reproduction area was evaluated taking the color reproduction area of Comparative Examples 1 was set as 100. Color reproduction area more than 105 is acceptable. The result is summarized in Table 1.

Herein, “L*a*b* color system” is a useful procedure to quantify color. A direction of L*-axis represents luminance, a direction of a*-axis represents a hue of red-green, a direction of b*-axis represents a hue of yellow-blue. a* and b* are measured by spectrophotometer “Gretag Macbeth Spectrolino” (manufactured by Gretag Macbeth), taking a D65 as the light source, using a 4 mm diameter reflection measurement aperture, with the measurement wavelength range being from 380 nm to 730 nm at 10 nm intervals and with the sight angle (observer) being 2 degrees, and under conditions of using a special white tile for matching with the standards.

### (2) Coloring Power of Secondary Color

Secondary color image reproduced by the superimpose of magenta toner image and orange toner image was formed on copy paper “POD Gloss coat paper (128 g/m2)” (product of Oji Paper Co., Ltd) and was evaluated by 10 examiners according to the following criteria. Adhesion amount of each toner was within the range of 1±0.2 g/m².

### —Evaluation Criteria—

A: Color cross-over was not observed and bright and brilliant color.
B: Color cross-over was not observed but slightly lack of brightness.
C: Color cross-over was observed and lack of brightness.

TABLE 1

| | | | | | | | Evaluation | |
|---|---|---|---|---|---|---|---|---|
| | Developer No. | | | | | | Result | |
| | Orange | Yellow | Magenta | Cyan | Green | Black | *1 | *2 |
| Inv. 1 | [1] | [1] | [1] | [1] | [1] | [1] | 120 | A |
| Inv. 2 | [2] | [2] | [2] | [2] | [2] | [2] | 121 | A |
| Inv. 3 | [3] | [1] | [1] | [1] | [1] | [1] | 116 | B |
| Inv. 4 | [4] | [2] | [2] | [2] | [2] | [2] | 117 | B |
| Comp. 1 | [5] | [1] | [1] | [1] | [1] | [1] | 100 | C |
| Comp. 2 | [6] | [2] | [2] | [2] | [2] | [2] | 100 | C |

*1: Color reproduction area,
*2: Color chroma

The results described in Table 1 clearly show that Examples 1-4 related to the present invention exhibits excellent color chroma of secondary color and give broader color reproduction area, compared to Comparative Examples 1 and 2.

### DESCRIPTION OF THE ALPHANUMERIC DESIGNATIONS

10Y, 10Or, 10M, 10C, 10G, and 10K: photoreceptor drum
11Y, 11Or, 11M, 11C, 11G, and 11K: charging member
12Y, 12Or, 12M, 12C, 12G, and 12K: exposing member
13Y, 13Or, 13M, 13C, 13G, and 13K: developing member
14Y, 14Or, 14M, 14C, 14G, and 14K: primary transfer member
141Y, 141Or, 141M, 141C, 141G, and 141K: primary transfer roll
14S: secondary transfer member
141S: secondary transfer roll
17: intermediate transfer belt
17a, 17b, 17c: supporting roller
17d: back up roll
18: fixing apparatus
181: heat roll
182: pressure roll
20Y, 20Or, 20M, 20C, 20G, and 20K: cleaning member
20S: intermediate transfer belt cleaning member
30Y, 30Or, 30M, 30C, 30G and 30K: toner image forming units
P: transfer body

What is claimed is:

1. A method for forming a full color image using at least six colors of an electrostatic image developing toner each comprising a binder resin and a colorant,
wherein the six colors of an electrostatic image developing toner are a yellow toner, a magenta toner, a cyan toner, an orange toner, a green toner and a black toner, and
the colorant contained in the orange toner is a pyrazolone pigment.

2. The method for forming a full color image of claim 1, wherein a content of the colorant contained in the orange toner is 1 to 6 parts by mass based on the resin of 100 parts by mass.

3. The method for forming a full color image of claim 1, wherein the colorant contained in the orange toner is one or more pigments selected from C.I. pigment orange 13 and C.I. pigment orange 34.

4. The method for forming a full color image of claim 1, wherein the colorant contained in the orange toner is C.I. pigment orange 13.

5. The method for forming a full color image of claim 1, wherein the colorant contained in the orange toner is C.I. pigment orange 34.

6. The method for forming a full color image of claim 1, wherein the six colors of an electrostatic image developing toner has a softening point (Tsp) of not less than 70° C. and not more than 110° C.

7. The method for forming a full color image of claim 1, wherein a fixing temperature is from 70° C. to 160° C.

8. The method for forming a full color image of claim 1, wherein the orange toner is prepared by step of coagulating and fusing fine particles of the colorant and fine particles of the resin by mixing a dispersion in which fine particles of the colorant is dispersed in an aqueous medium with a dispersion in which fine particles of the resin are dispersed in an aqueous medium.

9. An apparatus for forming a full color image, wherein the full color image is formed by the method of claim 1.
